(19) United States
(12) Patent Application Publication
(10) Pub. No.: US 2005/0288979 A1
(43) Pub. Date: Dec. 29, 2005

(54) System and method for mitigating inventory risk in an electronic manufacturing services-based supply chain management and manufacturing execution system

(75) Inventor: William K. Guest, Hampstead, NH (US)

Correspondence Address: HITT GAINES, PC;LUCENT TECHNOLOGIES INC., PO BOX 832570, RICHARDSON, TX, 75083, US

(73) Assignee: Lucent Technologies Inc., Murray Hill, NJ (US)

(21) Appl. No.: 10/868,727

(22) Filed: Jun. 15, 2004

(51) Int. Cl. G06F 17/60

(52) U.S. Cl. 705/7

(57) ABSTRACT

A system and method for mitigating inventory risk and an enterprise resource planning (ERP) system incorporating such system or method. In one embodiment, the system includes: (1) a uniqueness factor calculator configured to assign, to parts in an associated production database, uniqueness factors that are a function of a number of different products into which said parts go and (2) a risk report generator associated with said uniqueness factor calculator and configured to generate a report of risks associated with said products and based on said uniqueness factors.

### TECHNICAL FIELD OF THE INVENTION

The present invention is directed, in general, to computer-based production planning systems and, more specifically, to a system and method for mitigating inventory risk in an electronic manufacturing services (EMS)-based supply chain management and manufacturing execution system.

### BACKGROUND OF THE INVENTION

Many years ago, manufacturing, while rarely easy, was at least relatively straightforward. Manufacturers wishing to make a product found suppliers for the parts (e.g., raw material, components or subassemblies) that went into the product, stocked their inventories by purchasing quantities of the parts and managed those inventories by purchasing more parts as manufacturing requirements depleted them. Purchasing parts in advance of needing them was important, because they might not always be immediately available when ordered, and transportation was frequently unreliable. As a result, each manufacturer independently managed its own flow of parts and products, from beginning to end.

In today's world, manufacturing is no easer but is far more complex. Economists concluded several decades ago that inventories represent inefficient allocations of capital and should be minimized wherever possible. More recently, economists and investors have come to view large manufacturing facilities in the same light. In an effort to use their capital more effectively, manufacturers have adopted sophisticated and automated enterprise resource planning (ERP) systems, which make use of software and databases to effect manufacturing execution systems (MES), warehouse and transportation management systems (WMS/TMS) and supply chain management (SCM) systems, among others. Large, formerly self-sufficient manufacturers have taken advantage of these automated and distributed systems to contract out large portions of their manufacturing process to third parties.

In the specific field of electronic products, such manufacturers have begun to view themselves as the focal point of a hierarchical web of interdependent “electronic manufacturing services” (EMS) companies. Complex computer software executing on a computer network linking the various companies coordinates the overall manufacturing process to ensure that parts (“purchase parts”) are brought together into subassemblies and subassemblies are brought together into complete products and systems (“end items”) on time, at maximum efficiency and at minimum cost.

As mentioned above, minimizing inventories has long been a manufacturer's goal. The ideal is known as “just in time” (JIT) inventory control, which is supposed to guarantee that the first unit of new inventory arrives just as the last unit has been taken. However, JIT inventory control is predominantly a creature of theory. In practice, small inventories of parts are still required because immediate availability from suppliers and transportation reliability remain imperfect. Leadtimes are still a fact of life.

ERP has yielded mass quantities of data on parts cost, leadtimes, inventory levels (“potential burn”), the rate at which inventory is used for production (“burn rate”), labor costs, production scheduling and capacity and other factors of potential concern to a manufacturer. These data are stored in the massive production databases of ERP systems but must be analyzed and managed to be of real value.

However, no analytical technique exists for a manufacturer to assess the risk it faces that parts, subassemblies or the like may be “stranded” in inventory due to missed sales projections or canceled orders. No technique exists to quantify various inventory risks so they can be compared and dealt with on a priority basis. No technique exists to tell when inventory risk is about to be undertaken so decisions about whether or not to undertake that risk can be made intelligently. What is needed in the art is a way to measure and anticipate, and ultimately mitigate, inventory risk.

### SUMMARY OF THE INVENTION

To address the above-discussed deficiencies of the prior art, the present invention provides, in one aspect, a system for mitigating inventory risk. In one embodiment, the system includes: (1) a uniqueness factor calculator configured to assign, to parts in an associated production database, uniqueness factors that are a function of a number of different products into which the parts go and (2) a risk report generator associated with the uniqueness factor calculator and configured to generate a report of risks associated with the products and based on the uniqueness factors.

In another aspect, the present invention provides a method of mitigating risk. In one embodiment, the method includes: (1) assigning, to parts in an associated production database, uniqueness factors that are a function of a number of different products into which the parts go and (2) generating a report of risks associated with the products and based on the uniqueness factors.

In yet another aspect, the present invention provides an ERP system. In one embodiment, the system includes: (1) a data capturing system configured to collect data pertaining to leadtimes and costs of parts and production rates of products, (2) a production database associated with the data capturing system and configured to contain the leadtimes and costs of parts and production rates of products and (3) a system for mitigating inventory risk associated with the production database and including: (3a) a uniqueness factor calculator configured to assign, to the parts, uniqueness factors that are a function of a number of different products into which the parts go and (3b) a risk report generator associated with the uniqueness factor calculator and configured to generate a report of risks associated with the products and based on the uniqueness factors.

The foregoing has outlined, rather broadly, preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention in its broadest form.

### BRIEF DESCRIPTION OF THE DRAWINGS

For a more complete understanding of the present invention, reference is now made to the following descriptions taken in conjunction with the accompanying drawings, in which:

FIG. 1 illustrates a highly schematic representation of a hierarchy of electronic manufacturing services (EMS) partners coordinated by an associated enterprise resource planning (ERP) system containing a system or method for mitigating inventory risk constructed or carried out according to the principles of the present invention;

FIG. 2 illustrates a schematic diagram showing how inventory risk is incorporated into orderable components and order quantities;

FIG. 3 illustrates a spreadsheet regarding components and risks as a function of leadtime;

FIG. 4 illustrates a graphical representation of potential liability risk as a function of time;

FIG. 5 illustrates spreadsheets and a graph relating burn rate and requirements results organized by end item;

FIG. 6 illustrates two spreadsheets regarding potential inventory risk, one ranking end item by leadtime required and another ranking potential liability by purchase part;

FIG. 7 illustrates a two spreadsheets regarding components driving specific end item risk and end items driving specific purchase part risk;

FIG. 8 illustrates a block diagram of a system for mitigating inventory risk constructed according to the principles of the present invention; and

FIG. 9 illustrates a flow diagram of a method of mitigating inventory risk carried out according to the principles of the present invention.

### DETAILED DESCRIPTION

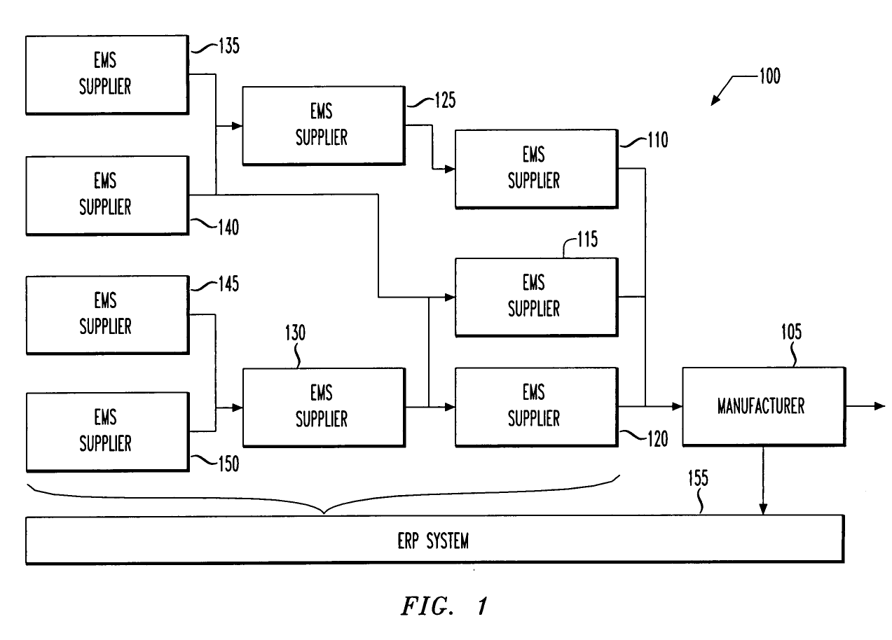

Referring initially to FIG. 1, illustrated is a highly schematic representation of a hierarchy 100 of EMS suppliers coordinated by an associated ERP system 155. A system or method for mitigating inventory risk constructed or carried out according to the principles of the present invention is associated with the ERP system 155.

A manufacturer 105 manufactures products, or “end items.” However, as described above, the manufacturer 105 does not manufacture those products from raw materials (“end-to-end.”) Instead, the manufacturer 105 relies on a tree-like network of EMS suppliers to manufacture components (parts, subassemblies or the like). FIG. 1 illustrates such a network of EMS suppliers, including EMS supplier 110, EMS supplier 115, EMS supplier 120, EMS supplier 125, EMS supplier 130, EMS supplier 135, EMS supplier 140, EMS supplier 145 and EMS supplier 150.

It is apparent from the arrangement of the EMS suppliers 110-150 that, for example, the EMS supplier 135 manufactures a component that is delivered to the EMS supplier 125. The EMS supplier 125 uses that component in the manufacture of a larger component that it then delivers to the EMS supplier 110. The EMS supplier 110 then uses that larger component in the manufacture of a still larger component that it then delivers to the manufacturer 105. Finally, the manufacturer 105 uses that still larger component in the manufacture of its product, or end unit. Of course, that product or end unit may be a component in still larger components or assemblies, and so on.

Note also that, while the EMS supplier 140 supplies a component to the manufacturer 105 through the EMS supplier 115, it also supplies a component in a more circuitous manner through the EMS supplier 125 and the EMS supplier 110. That component may be the same component or a different component and may be used in the same product or in a different product produced that the manufacturer 105 produces.

The ERP system 155 interconnects the manufacturer 105 and the EMS suppliers 110-150. As described above, the ERP system 115 is a computer-based information and communication system that collects production data from the various EMS suppliers 110-150 and makes that production data available to the manufacturer 105 to use in production planning and operations. The ERP system 155 may further provide information to the EMS suppliers 110-150. That information may rudimentarily be ordering information from the manufacturer 105, but could include information that could allow the EMS suppliers to refine their manufacturing processes. In one embodiment, the ERP system 105 is a commercially available ERP system. Those skilled in the pertinent art will understand, however, that other ERP systems of any level of sophistication and architecture fall within the broad scope of environments within which the present invention may operate.

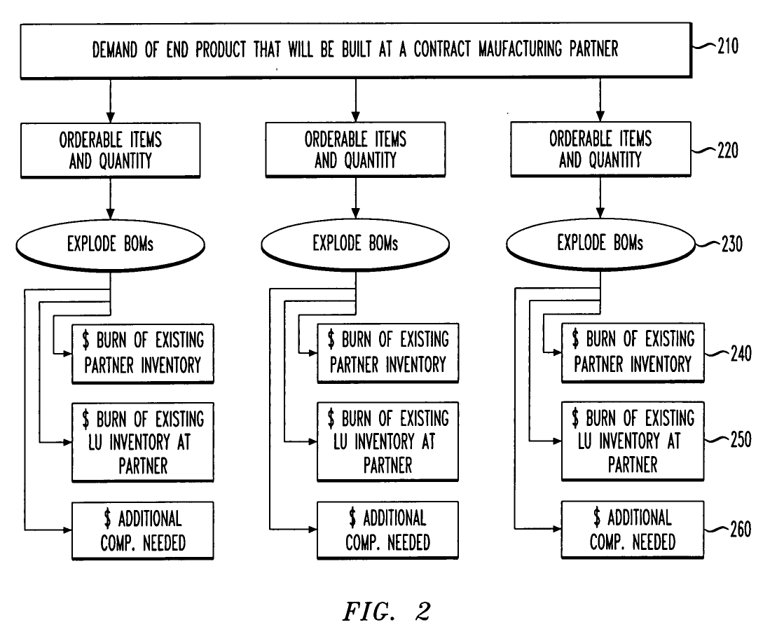

Turning now to FIG. 2, illustrated is a schematic diagram showing how inventory risk is incorporated into orderable components and order quantities. The demand 110 of an end product that is to be produced by an EMS supplier (also known as a “contract manufacturing partner”) is defined in terms of the orderable items and quantities of the various components that go into that end item. The orderable items and quantities are expressed in bills of material, or BOMs, associated with each of the EMS suppliers. For one EMS supplier, the orderable items and quantities is designated 120. An associated BOM 130 is broken down into its parts (or “exploded”) to reveal the inventories that exist at the EMS supplier in question. These inventories exist in three forms: (1) the EMS supplier's existing inventory of completed components 140, (2) the EMS supplier's existing inventory of components 150 that, purely with the addition of labor, will result in completed components, and (3) additional components 160 that needed to be ordered to transform further existing inventory of components into completed components.

Forms (1) and (2) do not represent risk, because they are already in existence and properly regarded as “sunk costs.” However, form (3), the additional components needed, does represent risk, because a purchase is required. Risk is present, because the resources consumed to make the purchase could result in stranded components instead of productive use. The present invention seeks to reduce that risk by identifying and quantifying it.

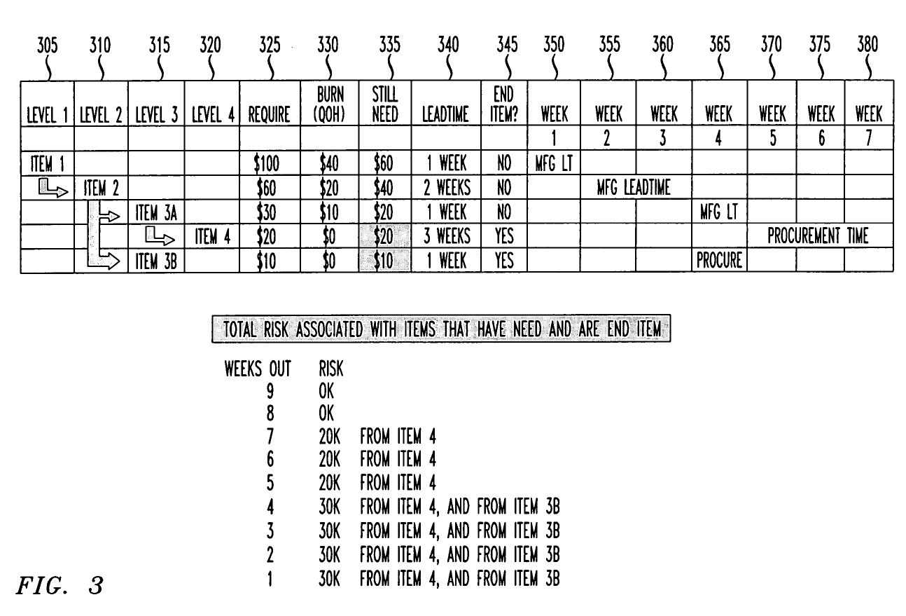

Turning now to FIG. 3, illustrated is a spreadsheet regarding components and risks as a function of leadtime. The spreadsheet is presented for the purpose of showing how inventory risk is encountered in a supply chain. The spreadsheet has a “level 1” column 305, a “level 2” column 310, a “level 3” column 315, a “level 4” column 320, a components required column 325, a component quantity on hand (QoH), or “burn” column 330, a component still needed column 335, a component leadtime column 340, an “end item?” column 345, and columns corresponding to weeks 350-380. The components required column 325, component “burn” column 330 and components still needed column 335 are expressed in thousands of dollars (K), though this is arbitrary given that FIG. 3 is just an example.

An exemplary BOM is exploded to reveal a component called “item 1.” Item 1 is located in the “level 1” column 305. Since item 1 is not an end item (per the “end item?” column 345), item 1 is exploded to reveal a component called “item 2,” which is located in the “level 2” column 310. Since item 2 is not an end item (again per the “end item?” column 345), item 2 is exploded to reveal two components called “item 3A” and “item 3B,” which are located in the “level 3” column 315. Item 3B is an end item (per the “end item?” column 345), so it cannot be exploded. However, item 3A is not. Item 3A is exploded to reveal “item 4,” which is located in the “level 4” column 320. Item 4 is an end-item, so the exploding is complete with respect to this rather simple example.

From FIG. 3, it is apparent that $100K of item 1 is required (see the components required column 325). From the component “burn” column 330, the QoH to fill that need is $40K. Thus, $60K of item 1 is still needed (see the component still needed column 335). Since item 2 must be purchased to make item 1, this $60K need is reflected in the line of the components required column 325 corresponding to item 2.

Given that $60K of item 2 is required and only $20K is available QoH (per the component “burn” column 330), $40K of item 2 is still needed. Since items 3A and 3B must be purchased to make item 2, this $40K need is reflected in the lines of the components required column 325 corresponding to items 3A and 3B. Note that the $40K purchase amount is broken into $30K and $10K purchases of items 3A and 3B, respectively.

Given that $30K of item 3A is required to make item 2 and only $10K is available QoH, $20K of item 3A must be purchased. This $20K need is reflected in the line of the component required column 325 corresponding to item 4. Since item 4 has no QoH whatsoever, all of that $20K must be purchased. Given that $10K of item 3B must be purchased to make item 2 and item 3B has no QoH whatsoever, all of that $10K must be purchased.

Having defined the relationships and costs involved, the issue becomes leadtime. Item 1 requires one week of leadtime to manufacture (see the component leadtime column 340). Item 2 requires two weeks of leadtime to manufacture. Item 3A requires a week of leadtime to manufacture. Items 3B and 4 are end items, so they must be procured rather than manufactured. Item 3B requires a week to procure; and item 4 requires a full three weeks to procure.

Combining the purchase requirements with the required leadtimes yields an understanding of the related inventory risk. No risk is undertaken until week 7, when item 4 must be procured. When item 4 is procured, $20K of risk is incurred. That risk holds constant until week 4, when item 3B must be procured and an additional $10K of risk incurred. The risk remains until the inventory is ultimately sold.

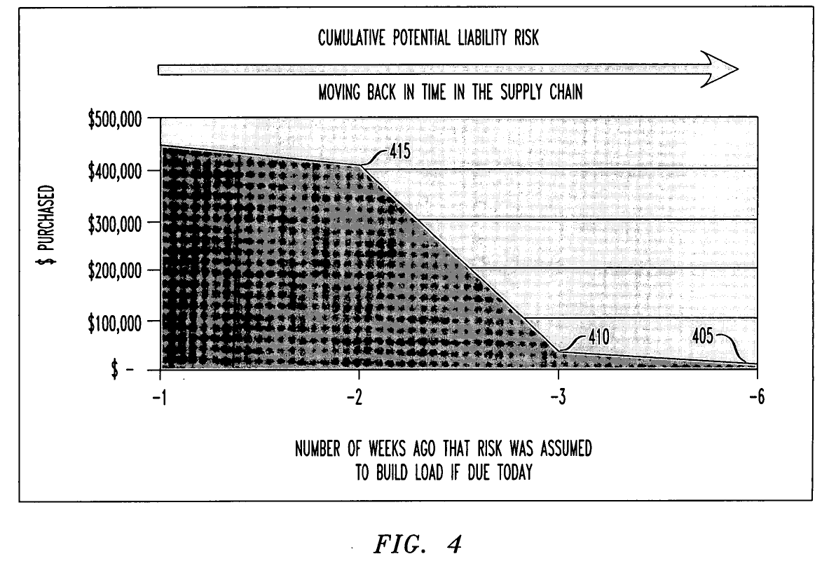

Turning now to FIG. 4, illustrated is a graphical representation of potential inventory liability risk as a function of time. The dollar amounts in FIG. 4 do not relate to those in FIG. 3; the two FIGUREs are separate examples. FIG. 4 is presented primarily for the purpose of showing that inventory risk is accrued over time as purchase decisions are made and only dissipated upon the actual sale of end-items.

In the example, inventory risk is not undertaken at all until six weeks before the sale of an end item (represented by a point 405). Inventory risk is undertaken only gradually from the point 405 to a point three weeks before the sale of an end item (represented by a point 410), at which point inventory risk is about $40K. Inventory risk then begins to accrue at a substantial rate, rising to over $400K in only a week's time. From that point (represented by a point 415), risk accrues at a much lower rate until the end item is finally sold. FIG. 4 communicates an important fact: that purchasing decisions are best made before substantial inventory risk is assumed and thus, in the instant case, three weeks before the end items are scheduled to be sold.

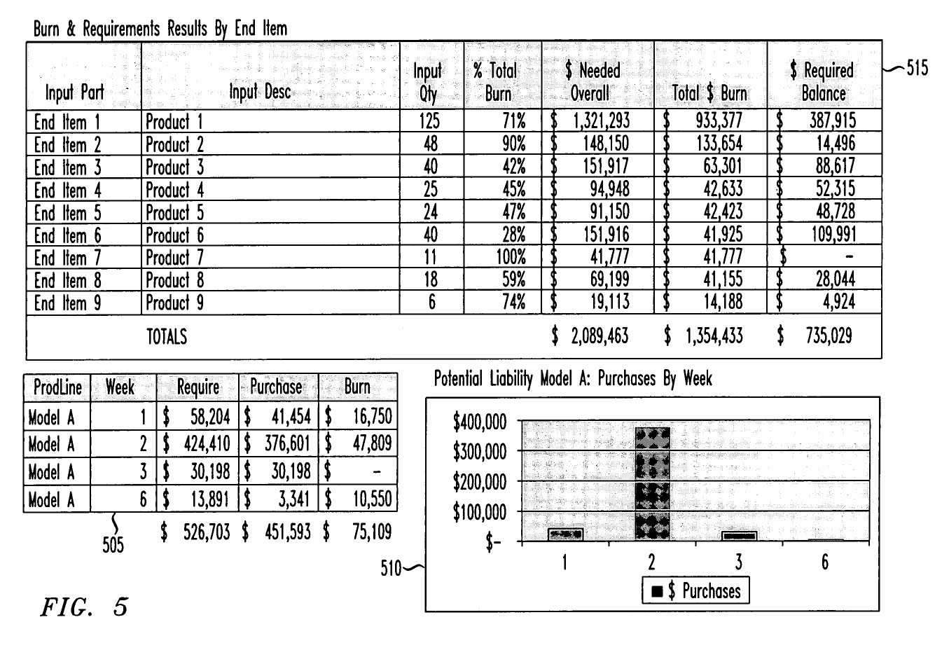

Turning now to FIG. 5, illustrated are spreadsheets and a graph relating burn rate and requirements results organized by end item.

A first spreadsheet 505 forms the basis for FIG. 4. The “purchase” column of the first spreadsheet 505 is the salient column, for it determines the components that must be purchased to produce a given number of end items, and thus the inventory risk that will ultimately be undertaken. Week 2 requires the largest purchase, which corresponds to the second week before the end items are scheduled to be sold. The graph, designated 510, bears out this purchase: week 2 encompasses far and away the largest purchase. The graph 510 is in fact a marginal risk form of the graph of FIG. 4.

A second spreadsheet 515 illustrates inventory risk relating to nine end items: end item 1 through end item 9. The second spreadsheet 515 is presented primarily for the purpose of illustrating that inventory risk is not based on absolute values. Were this to be the case, end item 1 would represent the greatest inventory risk since it has the largest balance required to be purchased (column 7). Instead, inventory risk is based on relative values. End item 6 in fact represents the greatest inventory risk because only 28% of the required inventory is already on hand (column 4); the remaining 72% must be purchased. End item 7 has no inventory risk whatsoever (column 4) because all of its inventory costs are sunk. Therefore, the larger the number in column 4, the smaller the inventory risk.

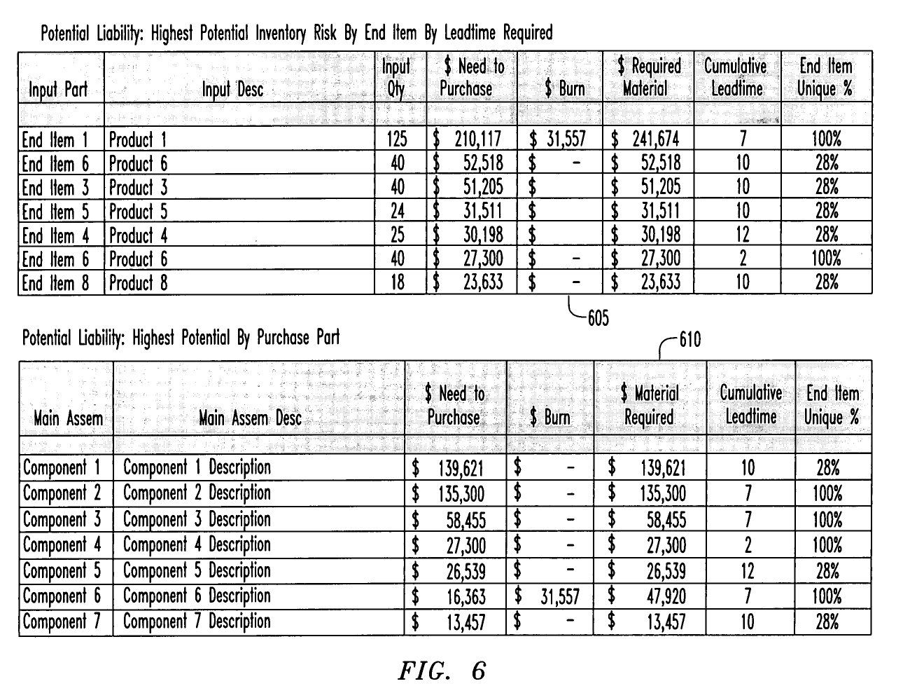

Turning now to FIG. 6, illustrated are two spreadsheets 605, 610 regarding potential inventory risk, one ranking end item by leadtime required and another ranking potential liability by purchase part. FIG. 6 represents two reports that the illustrated embodiment of a system constructed according to the principles of the present invention can generate.

FIG. 6 also introduces the novel concept of uniqueness factors. At this point, the way in which the uniqueness factors are calculated will not be introduced.

The first spreadsheet 605 ranks end items as follows: for each end item, the amount of the end item required to be purchased (column 4) is multiplied by the cumulative leadtime (column 7) and further by the uniqueness factor (column 8) pertaining to that end item. The resulting number not only reflects the magnitude of the end-item purchase and the length of time during which the inventory risk is assumed, but also employs the uniqueness factor as an indicator of other uses of the end item. The higher the uniqueness factor, the less likely the end item can find other use, and therefore the greater the inventory risk.

The second spreadsheet 610 sorts components by inventory risk. For each component, the amount of the component required to be purchased (column 3) is multiplied by the cumulative leadtime (column 6) and further by the uniqueness factor (column 7) pertaining to that end item. As above, the resulting number not only reflects the magnitude of the component purchase and the length of time during which the inventory risk is assumed, but also employs the uniqueness factor as an indicator of other uses of the component. The higher the uniqueness factor, the less likely the component can find other use, and therefore the greater the inventory risk.

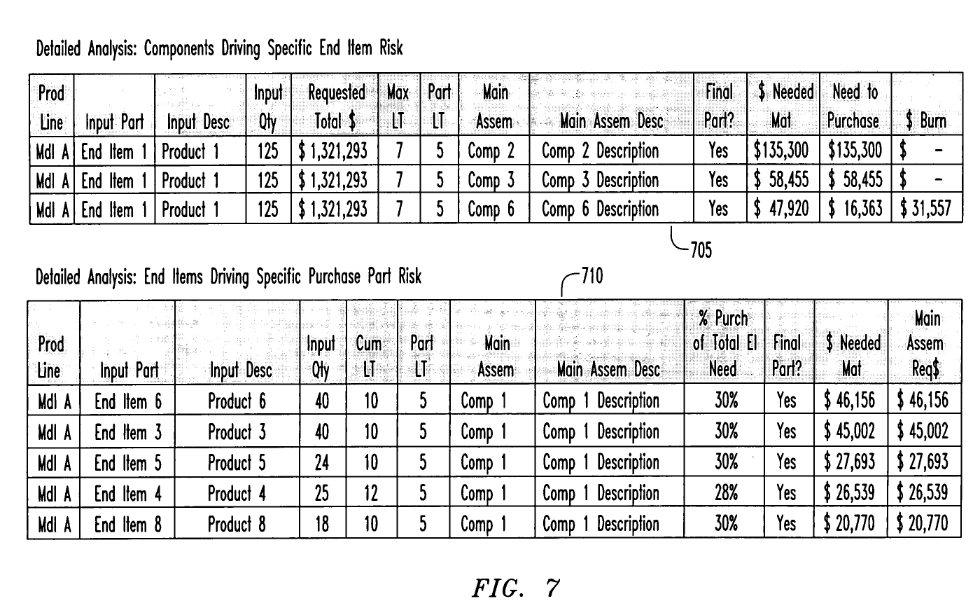

Turning now to FIG. 7, illustrated are two spreadsheets 705, 710 regarding components driving specific end item risk and end items driving specific purchase part risk.

Column 8 of the first spreadsheet 705 shows that three components, component 2, component 3 and component 6 go into end item 1. Column 10 of the first spreadsheet 705 shows that components 2, 3 and 6 are final parts or end items. By virtue of their order in the first spreadsheet 705, it is apparent that component 2 of end item 1 represents the greatest inventory risk.

In the illustrated embodiment of the second spreadsheet 710, the uniqueness factor of component 1 is calculated as follows: the amount of component 1 needed (column 11) for End Item 6, $46,156 is divided by the total amount needed of component 1 for all end item demand (column 11), $166,160, and is equal to 28%. Therefore, 28% of component 1's demand is driven by end item 6. In the same manner, 27% of component 1's demand is driven by end item 3, 17% is driven by end item 5, 16% is driven by end item 4, and 12% is driven by end item 8. The overall uniqueness factor for component 1 is set to the maximum (most conservative view) uniqueness factor of component 1, and therefore has a 28% uniqueness factor. This factor is a measurement of the uniqueness of component 1.

Spreadsheet 705 illustrates that end item 1 material needed (column 12) results from purchasing needs of component 2, component 3, and component 6. Using the algorithm outlined above, the uniqueness factors for component 2, component 3, and component 6 have been calculated and are identified in FIG. 6, spreadsheet 610 (column 7). The uniqueness factor of end item 1 is set to the maximum (most conservative view) uniqueness factor of component's 2, 3, and 6, and therefore equals 100%. The result is an end item unique % value of 100% for end item 1, as illustrated in FIG. 6, spreadsheet 605, column 8.

The logic used to identify the uniqueness factor can be duplicated to identify the uniqueness of a component demand within a grouping of end items, using the same process. The component uniqueness factor of a component as it relates to an aggregated view of demand within a grouped category of end items (where end items 6, end item 3, and end item 8 may be part of a specific grouping) can be calculated in the same manner. Once this is accomplished, the uniqueness factor of the group can then be established using the maximum of all component uniqueness values assigned to that group.

The uniqueness factors of subassemblies of components are based on the uniqueness factors of the components in those subassemblies. In the illustrated embodiment, the uniqueness factor of a particular subassembly is set equal to the highest uniqueness factor of its components. The underlying theory is one of conservatism. For example, if a subassembly is made up of components having uniqueness factors of 5%, 38% and 73%, the uniqueness factor of the subassembly is deemed to be 73%.

Those skilled in the art will understand, however, that other methods can be employed to assign uniqueness factors to subassemblies. For example, an unweighted mean of component uniqueness factors could be used. The median or mode of the component uniqueness factors could be used. Alternatively, a mean weighted by component value could be used. The present invention encompasses all methods for assigning uniqueness factors to subassemblies (remembering, of course, that one EMS supplier's subassembly may well be another EMS supplier's component).

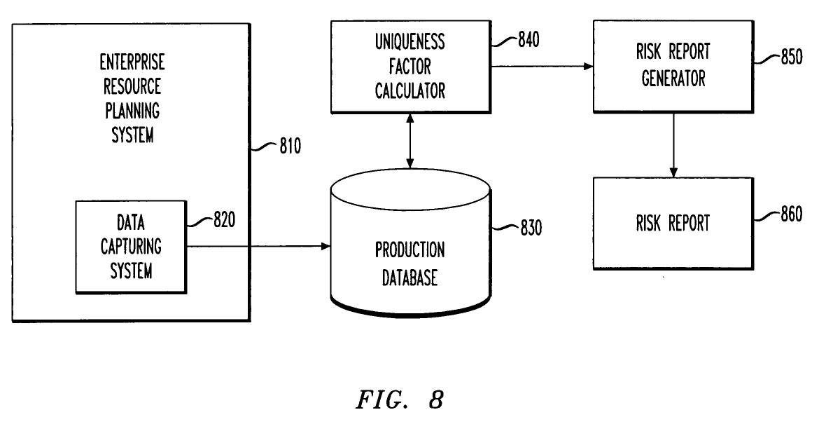

Turning now to FIG. 8, illustrated is a block diagram of a system for mitigating inventory risk constructed according to the principles of the present invention. An ERP system 810 includes a data capturing system 820. The data capturing system 820 is adapted to capture production data relating to parts (i.e., components, subassemblies or other synonymous terms) from a network of interacting EMS suppliers. The data capturing system 820 stores the production data in a production database 830.

The illustrated embodiment of the system for mitigating inventory risk employs a uniqueness factor calculator 840. The uniqueness factor calculator 840 is configured to assign, to parts in the production database 830, uniqueness factors that are a function of a number of different products into which the parts go. A risk report generator 850 is associated with the uniqueness factor calculator 840. The risk report generator 850 is configured to generate a risk report 860. The risk report 860 sets forth at least some of the inventory risks associated with the products and based on the uniqueness factors. In the illustrated embodiment, the risk report is one or both of the reports of FIG. 6.

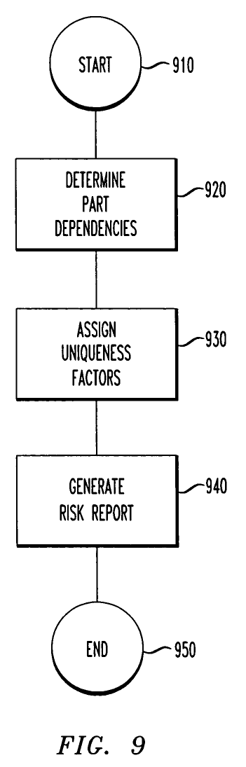

Turning now to FIG. 9, illustrated is a flow diagram of a method of mitigating inventory risk carried out according to the principles of the present invention.

The method begins in a start step 910 wherein it is desired to analyze risks associated with an inventory of electronic parts (e.g., electronic components, electronic subassemblies and other inputs to a process). The method first calls for part dependencies to be determined in a step 920. Thus, end items are broken down into subassemblies and further into parts or components to result in a tree of dependencies. The method proceeds to a step 930 in which uniqueness factors are assigned to parts (including subassemblies and the like) in an associated production database.

The production database may be distributed among a plurality of EMS companies and may be part of an ERP system. The uniqueness factors are a function of a number of different products into which the parts go. The uniqueness factors may vary linearly as a function of the number of different products or may vary at a higher order. In the illustrated embodiment, the uniqueness factors vary inversely to the number of different products.

The method then proceeds to a step 940 in which a report of risks associated with the products and based on the uniqueness factors is generated. The risks may be a function of production levels of the different products or further may be a function of leadtimes of the different products. The report may be used to adjust leadtimes of parts that are more unique and therefore represent more risk. The report may also be used to identify parts that may be made more common and therefore less risky.

Although the present invention has been described in detail, those skilled in the pertinent art should understand that they can make various changes, substitutions and alterations herein without departing from the spirit and scope of the invention in its broadest form.

1. A system for mitigating inventory risk, comprising:
a uniqueness factor calculator configured to assign, to parts in an associated production database, uniqueness factors that are a function of a number of different products into which said parts go; and
a risk report generator associated with said uniqueness factor calculator and configured to generate a report of risks associated with said products and based on said uniqueness factors.

2. The system as recited in claim 1 wherein said uniqueness factors vary linearly as a function of said number of different products.

3. The system as recited in claim 1 wherein said risks are a function of production levels of said different products.

4. The system as recited in claim 1 wherein said risks are a function of leadtimes of said different products.

5. The system as recited in claim 1 wherein said parts are selected from the group consisting of:
electronic components, and
electronic subassemblies.

6. The system as recited in claim 1 wherein said production database is distributed among a plurality of electronic manufacturing services (EMS) companies.

7. The system as recited in claim 1 wherein said production database is part of an enterprise resource planning (ERP) system.

8. A method of mitigating inventory risk, comprising:
assigning, to parts in an associated production database, uniqueness factors that are a function of a number of different products into which said parts go; and
generating a report of risks associated with said products and based on said uniqueness factors.

9. The method as recited in claim 8 wherein said uniqueness factors vary linearly as a function of said number of different products.

10. The method as recited in claim 8 wherein said risks are a function of production levels of said different products.

11. The method as recited in claim 8 wherein said risks are a function of leadtimes of said different products.

12. The method as recited in claim 8 wherein said parts are selected from the group consisting of:
electronic components, and
electronic subassemblies.

13. The method as recited in claim 8 wherein said production database is distributed among a plurality of electronic manufacturing services (EMS) companies.

14. The method as recited in claim 8 wherein said production database is part of an enterprise resource planning (ERP) system.

15. An enterprise resource planning (ERP) system, comprising:
a data capturing system configured to collect data pertaining to leadtimes and costs of parts and production rates of products;
a production database associated with said data capturing system and configured to contain said leadtimes and costs of parts and production rates of products; and
a system for mitigating inventory risk associated with said production database and including:
a uniqueness factor calculator configured to assign, to said parts, uniqueness factors that are a function of a number of different products into which said parts go, and
a risk report generator associated with said uniqueness factor calculator and configured to generate a report of risks associated with said products and based on said uniqueness factors.

16. The system as recited in claim 15 wherein said uniqueness factors vary linearly as a function of said number of different products.

17. The system as recited in claim 15 wherein said risks are a function of production levels of said different products.

18. The system as recited in claim 15 wherein said risks are a function of leadtimes of said different products.

19. The system as recited in claim 15 wherein said parts are selected from the group consisting of:
electronic components, and
electronic subassemblies.

20. The system as recited in claim 15 wherein said production database is distributed among a plurality of electronic manufacturing services (EMS) companies.
